(19) United States
(12) Patent Application Publication
(10) Pub. No.: US 2005/0104893 A1
(43) Pub. Date: May 19, 2005

(54) Three dimensional image rendering apparatus and three dimensional image rendering method

(75) Inventors: Yasuyuki Kii, Nara (JP); Isao Nakamura, Osaka (JP)

Correspondence Address: NIXON & VANDERHYE, PC, 1100 N GLEBE ROAD, 8TH FLOOR, ARLINGTON, VA, 22201-4714, US

(73) Assignee: Sharp Kabushiki Kaisha, Osaka (JP)

(21) Appl. No.: 10/946,615

(22) Filed: Sep. 22, 2004

(30) Foreign Application Priority Data
Sep. 26, 2003 (JP) 2003-336501

(51) Int. Cl. G06F 13/00; G09G 5/02; G06T 15/00; G06T 15/40

(52) U.S. Cl. 345/589; 345/422; 345/419

(57) ABSTRACT

A three dimensional image rendering apparatus for rendering polygons forming a three dimensional object on a two dimensional display screen, comprising: a hidden surface removal section for performing a hidden surface removal process by, when a part or all of the pixels forming the two dimensional display screen belong to a first polygon which is closest to a point of view, updating memory contents in an information memory section to information of the first polygon; and a blending section for obtaining, based on edge identification information for indicating whether the respective pixels are located on an edge of the first polygon and a percentage of an area in the respective pixels occupied by the first polygon as part of information of the first polygon, the color information of the respective pixels from color information as another part of the first polygon.

This Nonprovisional application claims priority under 35 U.S.C. §119(a) on patent application No. 2003-336501 filed in Japan on Sep. 26, 2003, the entire contents of which are hereby incorporated by reference.

### BACKGROUND OF THE INVENTION

1. Field of the Invention

The present invention relates to a three dimensional image rendering apparatus and a three dimensional image rendering method which is used for a portable electronic device such as a portable game device, and renders a three dimensional image (3D image) on a two dimensional display screen thereof.

2. Description of the Related Art

Conventionally, for rendering a three dimensional object on a two dimensional display screen such as a portable game device, an image has been generally formed of dots (pixels). Thus, the image has jagged edges, and the displaying definition is decreased. Such a phenomenon is called ailiasing.

For reducing such ailiasing to smooth the edges, anti-ailiasing methods, for example, a super sampling method and a filtering method are mainly used.

In the super sampling method, an image having the size N times (vertical direction) and M times (horizontal direction) as large as the dot size of a two dimensional display screen is previously produced. Then, color data for N pixels×M pixels are blended to obtain a display image.

In the filtering method, color data (target data) of each of the dots in the image data is blended with color data of surrounding dots based on weighted coefficient values to obtain a display image. Such an anti-ailiasing method is proposed in detail, for example, in Japanese Laid-Open Publication No. 4-233086.

For displaying a three dimensional object on a two dimensional display screen, a three dimensional image (3D image) such as a ball, curved line and the like is displayed (represented) using many triangles and/or rectangles, for example, in order to facilitate calculations. Such a triangle and a rectangle are called polygons. The polygons are formed of a number of dots (pixels).

The above conventional super sampling method has a high ailiasing removing ability, but requires a memory capacity N×M times as large as that for the number of pixels in the display screen. Furthermore, a period of time becomes longer by N×M times for rendering an image. Thus, it is a time-consuming process and is not suitable for a real time process.

Since the above conventional time filtering method does not take time as compared to a super sampling method, it is suitable for a real time process. However, since an image is blurred in general, a problem that an image display definition decreas occurs.

### SUMMARY OF THE INVENTION

According to one aspect of the present invention, there is provided a three dimensional image rendering apparatus for rendering polygons forming a three dimensional object on a two dimensional display screen, comprising: a hidden surface removal section for performing a hidden surface removal process by, when a part or all of the pixels forming the two dimensional display screen belong to a first polygon which is closest to a point of view, updating memory contents in an information memory section to information of the first polygon; and a blending section for obtaining, based on edge identification information for indicating whether the respective pixels are located on an edge of the first polygon and a percentage of an area in the respective pixels occupied by the first polygon as part of information of the first polygon, the color information of the respective pixels from color information as another part of the first polygon, and outputting the color information of the respective pixels as pixel data.

In one aspect of the present invention, the hidden surface removal section may further update, when the respective pixels belong to the first polygon and also to a second polygon which is the second closest to the point of view memory contents of the information memory means regarding the second polygon to information of the second polygon, and the blending section may mix, based on the edge identification information and the percentage of the area as the part of the information of the first polygon, the color information as another part of the information of the first polygon, and color information as a part of the information of the second polygon to obtain color information of the respective pixels, and may output the color information of the respective pixels as pixel data.

In one aspect of the present invention, the information memory section may include a first color memory section for storing the color information of the first polygon, a first depth memory section for storing a depth value of the first polygon, an edge identification memory section for storing the edge identification information for indicating whether the respective pixels are located on the edge of the first polygon, a mixing coefficient memory section for storing the percentage of the area in the respective pixels which is occupied by the first polygon, a second color memory section for storing the color information of the second polygon which is located second closest to the point of view, and a second depth memory section for storing a depth value of the second polygon; and the hidden surface removal section may obtain the color information, the depth value, the identification information, and the percentage of the area of the first polygon as the information of the first polygon, and the color information and the depth value of the second polygon as the information of the second polygon.

In one aspect of the present invention, the hidden surface removal section may include a polygon determination section for receiving graphic data as an input including endpoint information and color information of the polygon, which are transformed into a view coordinate system, obtaining depth values for the respective pixels from the endpoint information of the polygon, and, based on the depth values, determining whether the part or all of the pixels respectively belong to the first polygon which is closest to the point of view and/or to the second polygon which is second closest to the point of view.

In one aspect of the present invention, the hidden surface removal section may update the memory contents of the first color memory section, the first depth memory section, the edge identification information memory section, the mixing coefficient memory section, the second color memory section and the second depth memory section using the information of the first polygon, when the part or all of the pixels respectively belong to the first polygon.

In one aspect of the present invention, the hidden surface removal section may further update the memory contents of the second color memory section, and the second depth memory section using the information of the second polygon when the respective pixels respectively belong to the first polygon and the second polygon.

In one aspect of the present invention, the blending section may mix the memory contents of the first color memory section and the memory contents of the second color memory section, based on the memory contents of the edge identification information memory section and the mixing coefficient memory section to obtain color information of the respective pixels, and may output the color information of the respective pixels as image data.

In one aspect of the present invention, the first color memory section, the fist depth memory section, the edge identification information memory section, the mixing coefficient memory section, the second color memory section and the second depth memory section may respectively have memory capacities corresponding to one line in the display screen, and the hidden surface removal section and the blending section may perform processing for every line of one screen.

According to another aspect of the present invention, there is provided a three dimensional image rendering method for rendering polygons forming a three dimensional object on a two dimensional display screen, comprising: a first step of obtaining information of at least one of a first polygon which is closest to a point of view and a second polygon which is second closest to the point of view for respective pixels forming the display screen; and a second step of mixing color information of the first polygon and color information of the second polygon based on edge identification information indicating whether the respective pixels are located on an edge of the first polygon, and the percentage of the area in the respective pixels which is occupied by the first polygon to obtain color information of the respective pixels, and outputting the color information of the respective pixels as image data.

In one aspect of the present invention, the first step may receive graphic data as an input, including endpoint information and color information of the polygon, which are transformed into a view coordinate system, may obtain depth values for the respective pixels from the endpoint information of the polygon, and, based on the depth values, may obtain the color information of the first polygon, a depth value of the first polygon, the edge identification information indicating whether the respective pixels are located on the edge of the first polygon, the percentage of the area in the respective pixels occupied by the first polygon, the color information of the second polygon, and a depth value of the second polygon.

Hereinafter, the effects of the present invention with the above-described structure will be described.

According to the present invention, when polygons forming a three dimensional object are rendered on a two dimensional display screen, an anti-ailiasing process for making the jagged edges less noticeable is performed as follows. Regarding respective pixels, the color of a polygon which is closest to a certain point of view, among a plurality of polygons (first polygon), and the color of a polygon next to (further than) the first polygon from the certain point of view (second polygon) are used. A color obtained by mixing (blending) two colors is used to display an edge portion.

The hidden surface removal section, by using graphic data of endpoint information and color information of the polygons forming a three dimensional object, which are transformed into a view coordinate system, for respective pixels, depth values are obtained from the end point information of the polygon. Based on the depth values, the information of the first polygon and the second polygon are obtained and stored in a memory means. As the information of the first polygon and the second polygon, first color memory means stores the color information of the first polygon, first depth memory means stores the depth value of the first polygon, edge identification memory means stores whether the respective pixels are located on an edge of the first polygon, and mixing coefficient memory means stores the percentage of the area in the respective pixels occupied by the first polygon (mixing coefficient). Further, second color means stores the color information of the second polygon, and second depth memory means stores the depth value of the second polygon.

The blending section mixes the color information of the first polygon and the color information of the second polygon based on the mixing coefficient when the respective pixels are located on the edge of the first polygon to obtain color information of the respective pixels.

Thus, in the edge portion of the first polygon, the respective pixels are displayed with the color information of the first polygon, and the color information of the second polygon mixed together based on the edge identification information and the percentage of the area in the pixels. This can suppress an occurrence of a blurred image. Since the color information to be mixed is the color information of the first polygon and the color information of the second polygon for respective pixels, a large memory capacity and a long processing time, as in the conventional super sampling method, is not necessary. Thus, the anti-ailiasing process can be performed at a high speed.

It is also possible to provide the first color memory means and the first depth memory means, the edge identification information memory means, the mixing coefficient memory means, the second color memory means, and the second depth memory means with a capacity corresponding to one line in the display screen, and the hidden surface removal section and the blending section performs a process for every line of one screen. This allows to further reduce the required memory capacity. Thus, the three dimensional image rendering apparatus according to the present invention can be readily mounted in a portable electronic device such as a portable game device.

According to the present invention, graphic data including endpoint information and color information of the polygons forming a three dimensional object, which are transformed into a view coordinate system, are input. Based on the depth values of the polygons, the hidden surface removal process is performed to obtain information of the first polygon which is closest to the point of view, and information of the second polygon which is the second closest to the point of view for respective pixels. The color information of the first polygon, the edge identification information, the percentage of the area in the respective pixels, and the color information of the second polygon are stored into a memory means. By blending the color information of the first polygon and the color information of the second polygon based on the edge identification information and the percentage of the area relative to the pixel of the first polygon, it is possible to render an image with reduced ailiasing. Thus, an anti-ailiasing process can be performed without requiring a large amount of memory region or long processing time, unlike the conventional method such as a super sampling method, or without resulting in a generally blurred image, unlike another conventional method such as a filtering method.

Thus, the invention described herein makes possible the advantages of providing a three dimensional image rendering apparatus and a three dimensional image rendering method, which can reduce ailiasing with a smaller amount of memory capacity compared to that in the super sampling method and at a high speed, and which can produce a three dimensional image having a high image display definition.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing the structure of a three dimensional image rendering apparatus according to one embodiment of the present invention.

FIG. 2 is a diagram showing an exemplary hidden surface removal process operation step according to the present invention.

FIG. 3 is a diagram showing an exemplary hidden surface removal process operation step according to the present invention.

FIG. 4 is a diagram showing an exemplary blending process operation step according to the present invention.

FIG. 5 is a flow diagram for illustrating an outline of the hidden surface removal process performed by the hidden surface removal section 1 of FIG. 1, and various polygon information storage processes.

FIG. 6 is a flow diagram for illustrating the process performed in step S3 during the hidden surface removal process of FIG. 5.

FIG. 7 is a flow diagram for illustrating the process to be performed in the hidden surface removal process operation (step S13 of FIG. 6) for one polygon shown in FIG. 6.

FIG. 8 is a flow diagram for illustrating an outline of a blending process performed by the blending section of FIG. 1.

FIG. 9 is a flow diagram for illustrating a process performed in the blending process operation of FIG. 8 (step S42).

### DESCRIPTION OF THE PREFERRED EMBODIMENTS

Hereinafter, the embodiments of a three dimensional image rendering apparatus and a three dimensional image rendering method according to the present invention will be described with reference to the drawings.

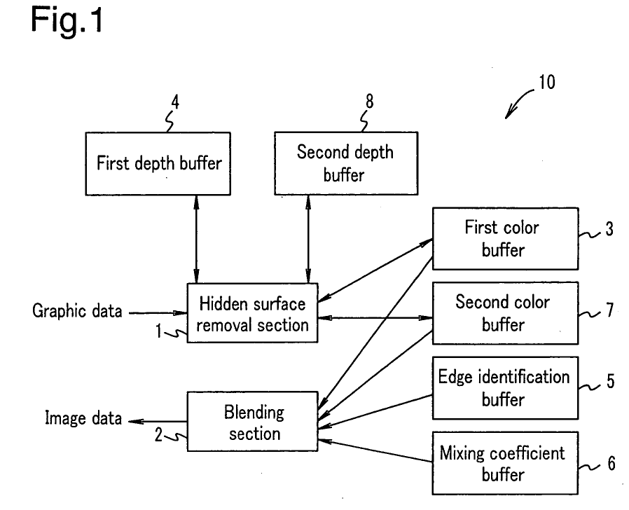

FIG. 1 is a block diagram showing the structure of a three dimensional image rendering apparatus according to one embodiment of the present invention.

As shown in FIG. 1, a three dimensional image rendering apparatus 10 includes: a hidden surface removal section 1 formed of a hidden surface removal circuit; a blending section 2 formed of a blending circuit; a first color buffer 3 as first color memory means; a first depth buffer 4 as first depth memory means; an edge identification buffer 5 as an edge identification information memory means; a mixing coefficient buffer 6 as a mixing coefficient memory means; a second color buffer 7 as a second color memory means; and a second depth buffer 8 as a second depth memory means. The three dimensional image rendering apparatus 10 renders polygons which form a three dimensional object on a two dimensional display screen. The buffers 3 through 8 form information memory means.

The hidden surface removal section 1 obtains a depth value from endpoint information of polygons forming a three dimensional object for each of the pixels which form the display screen, based on input graphic data including endpoint information and color information of the polygons forming the three dimensional object, which are transformed into a view coordinate system. Based on the depth value, information of a first polygon which is closest to the point of view and information of a second polygon, which is second closest to the point of view are obtained. Using the information of the first polygon, data of the first color buffer 3, the first depth buffer 4, the edge identification buffer 5 and the mixing coefficient buffer 6 are updated. Using the information of the second polygon, the data of the second color buffer 7 and the second depth buffer 8 are updated. As used herein, a hidden surface removal process refers to a process of removing a hidden surface of the information of the polygon (the second polygon) located behind the polygon, which is closest to the point of view, in the three dimensional image rendering apparatus 10 according to the present invention.

The hidden surface removal section 1 includes a polygon determination means (not shown) for determining whether a part, or all, of respective pixels belong to the first polygon and/or belong to the second polygon based on the depth value. Furthermore, the hidden surface removal section 1 includes a memory contents updating means (not shown) for updating the memory contents of the first color buffer 3, the first depth buffer 4, the edge identification buffer 5, the mixing coefficient buffer 6, the second color buffer 7 and the second depth buffer 8, using the information of the first polygon when the part, or all, of respective pixels belongs to the first polygon. The hidden surface removal section 1 also includes memory contents updating means (not shown) for further updating the memory contents of the second color buffer 7 and the second depth buffer 8, using the information of the second polygon when the pixels respectively belong to the first polygon and the second polygon.

Based on the data of the edge identification buffer 5 and the mixing coefficient buffer 6 after the hidden surface removal is performed, the blending section 2 blends color information of the first polygon and color information of the second polygon in an edge portion of the first polygon to obtain color information of the pixels. Thus, image data with reduced ailiasing is output.

The first color buffer 3 stores the color information of the first polygon which is closest to the point of view.

The first depth buffer 4 stores the depth value of the first polygon.

The edge identification buffer 5 stores edge identification information for indicating whether the pixels are located on the edge of the first polygon.

The mixing coefficient buffer 6 stores the percentage of the area in the pixel, which is occupied by the first polygon.

The second color buffer 7 stores color information of the second polygon which is the second closest to the point of view.

The second depth buffer 8 stores the depth value of the second polygon.

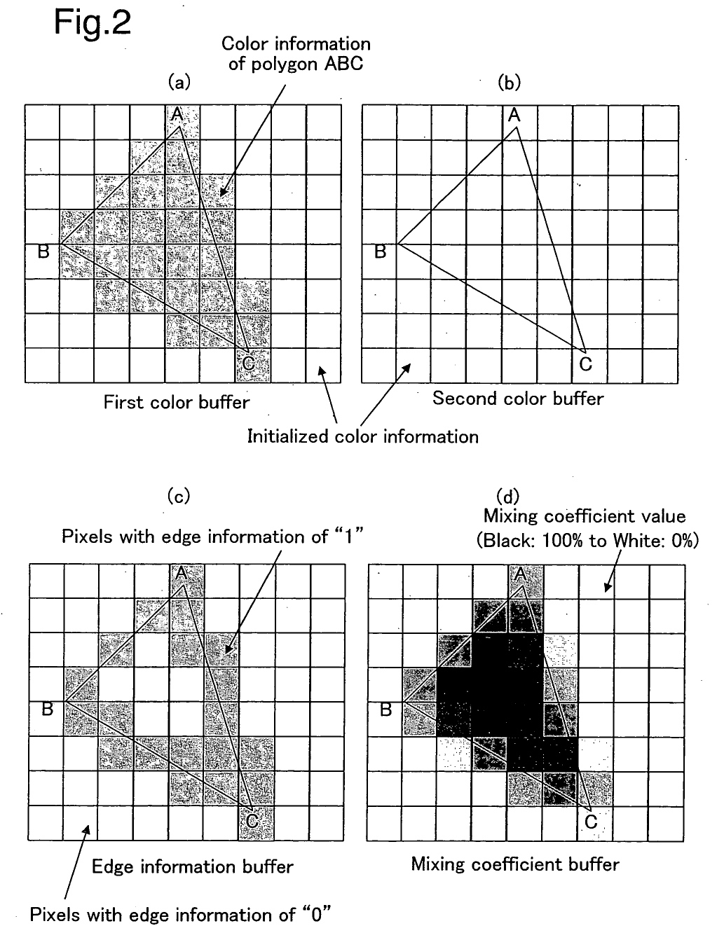

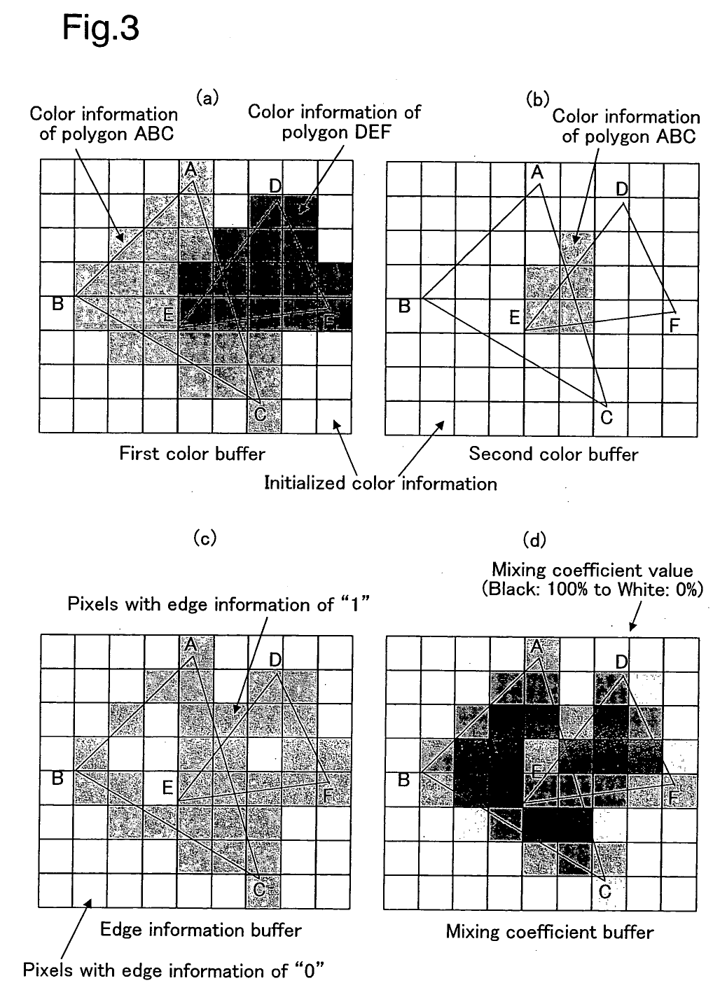

FIGS. 2 and 3 illustrate steps of a hidden surface removal process by the hidden surface removal section 1 when two polygons, polygon ABC and polygon DEF, are rendered.

In FIG. 2, (a) indicates a value of the first color buffer 3 when a process for a first polygon, polygon ABC, is performed by the hidden surface removal section 1 of FIG. 1; (b) indicates a value of the second color buffer 7 when a process for polygon ABC is performed by the hidden surface removal section 1 of FIG. 1; (c) indicates a value of the edge identification information buffer 5 when a process for polygon ABC is performed by the hidden surface removal section 1 of FIG. 1; and (d) indicates a value of the mixing coefficient buffer 6 when a process for polygon ABC is performed by the hidden surface removal section 1 of FIG. 1.

As indicated by (a) in FIG. 2, the first color buffer 3 stores color information of polygon ABC for the pixels which are included in the polygon ABC, and the initialized color information for the pixels which are not included in polygon ABC. As indicated by (b) in FIG. 2, the second color buffer 7 stores only the initialized information. In FIG. 2, pixels which store color information are hatched.

As indicated by (c) in FIG. 2, the edge identification information buffer 5 stores “1” for pixels on the edges of polygon ABC and “0” for other pixels. As indicated by (d) in FIG. 2, the mixing coefficient buffer 6 stores the percentage of the areas in the respective pixels included in polygon ABC, which are occupied by the polygon, which ranges from 100% (black) to 0% (white).

FIG. 3 shows an example where the second polygon, polygon DEF, is processed by the hidden surface removal section 1 after the process as shown in FIG. 2. Polygon DEF (second polygon) of FIG. 3 is located closer to the point of view compared to polygon ABC (first polygon). For the area in which polygon ABC and polygon DEF overlap, color information of polygon DEF which is closest to the point of view is stored in the first color buffer 3 indicated by (a) in FIG. 3, and color information of polygon ABC which is second closest to the point of view (located behind polygon DEF) is stored in the second color buffer 7 indicated by (b) in FIG. 3. The edge identification buffer 5 and the mixing coefficient buffer 6 indicated by (c) and (d) in FIG. 3 respectively store information of the polygon which is closest to the point of view.

In FIG. 3, (a) indicates a value of the first color buffer 3 when a process for the second polygon, polygon DEF, is further performed by the hidden surface removal section 1 after the process is performed as shown in FIG. 2; (b) indicates a value of the second color buffer 7 when a process for polygon DEF is further performed by the hidden surface removal section 1 after the process is performed as shown in FIG. 2; (c) indicates a value of the edge identification information buffer 5 when a process for polygon DEF is further performed by the hidden surface removal section 1 after the process is performed as shown in FIG. 2; and (d) indicates a value of the mixing coefficient buffer 6 when a process for polygon DEF is further performed by the hidden surface removal section 1 after the process is performed as shown in FIG. 2.

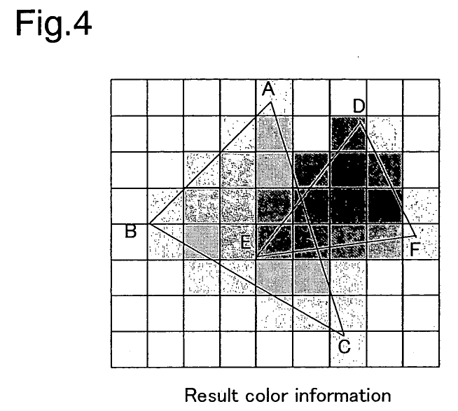

After the surface removal processes are performed by the hidden surface removal section 1 as described above, the blending section 2 blends color information of the first color buffer 3, and color information of the second color buffer 7, based on the value of the edge identification information buffer 5 and the value of the mixing coefficient buffer 6. Thus, a resultant image of the blending process by the blending section 2 is shown in FIG. 4.

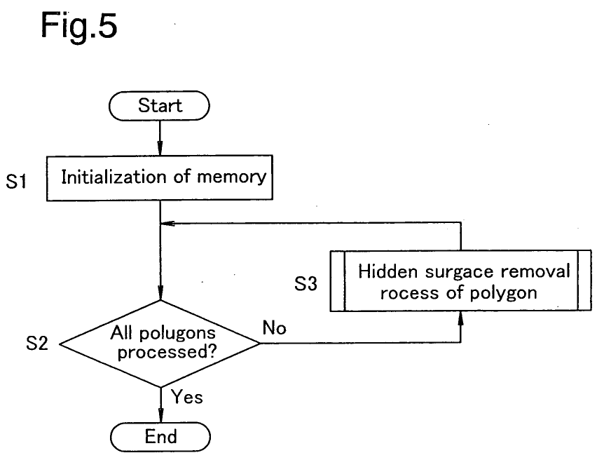

Next, with reference to flow diagrams of FIGS. 5 through 7, an operation of the hidden surface removal section 1 will be further described.

FIG. 5 is a flow diagram for illustrating an outline of the hidden surface removal process performed by the hidden surface removal section 1 of FIG. 1 and various polygon information storage processes.

As shown in FIG. 5, in step S1, the buffers 3 through 8 are initialized. The initialization processes for the buffers 3 through 8 are performed by writing designated values into all of the areas in which information corresponding to the respective pixels is stored in the buffers 3 through 8.

For example, the first color buffer 3 and the second color buffer 7 are initialized by using certain color information which has been previously set. Such information is usually white or black. The first depth buffer 4 and the second depth buffer 8 are initialized by certain depth value information which has been previously set. Such depth value information is usually a maximum depth value.

The edge identification buffer 5 is initialized with “0”. The mixing coefficient buffer 6 is also initialized with “0”. In the present embodiment, values corresponding to respective pixels of the edge identification buffer 5 are “0” or “1”. “0” indicates that the edge of the first polygon which is closest to the point of view is not located in a corresponding pixel portion. “1” indicates that the edge of the polygon which is closes to the point of view is located in a corresponding pixel portion. The values of the mixing coefficient buffer 6 which correspond to respective pixels are “0” through “100”. The number indicates the percentage of the area in the corresponding pixel portion, which is occupied by the polygon closest to the point of view.

Next, in step S2, it is determined whether the hidden surface removal processes are performed for all of the pixels of the polygon. If there is a pixel of the polygon which is not treated with the hidden surface removal process, the method proceeds to the process in step S3 for performing the hidden surface removal for the respective polygons. When the hidden surface removal processes are completed for all the pixels of the polygons, the hidden surface removal process is completed.

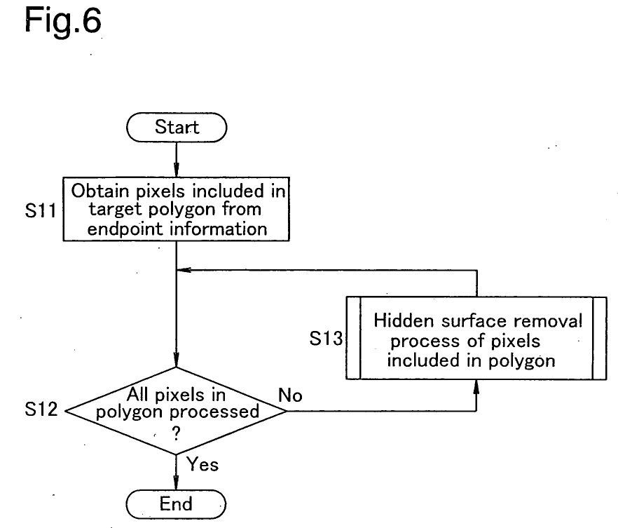

FIG. 6 is a flow diagram for illustrating the process performed in step S3 during the hidden surface removal process of the polygons of FIG. 5. Hereinafter, the hidden surface removal process for one polygon will be described with reference to FIG. 6.

As shown in FIG. 6, in step S11, pixels included in polygon p, which is a target at the moment, are obtained from endpoint information of polygon p.

Next, in step S12, it is determined whether the hidden surface removal process for a pixel included in polygon p is completed for all the obtained pixels. If there is a pixel included in polygon p, which is not treated with the hidden surface removal process, the method proceeds to the process of step S13. When the hidden surface removal process is completed, the hidden surface removal process for polygon p which is a target at the moment is completed.

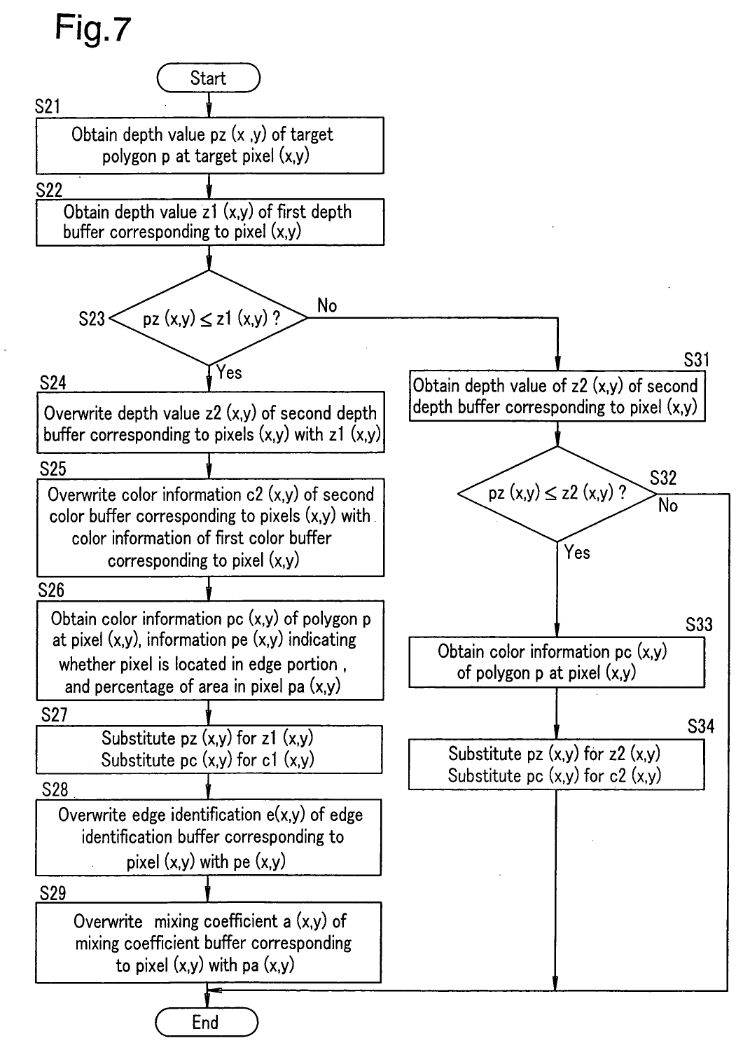

The hidden surface removal process (step S13 of FIG. 6) for a pixel included in a polygon (for example, polygon p, which is a target at the moment) will be described in detail with reference to FIG. 7.

FIG. 7 is a flow diagram for illustrating the process to be performed in the hidden surface removal process operation (step S13 of FIG. 6) for one polygon shown in FIG. 6.

As shown in FIG. 7, in step S21, a depth value of polygon p, which is a target at the moment, at a pixel(x, y) included in polygon p, pz(x,y), is obtained. By using, for example, XYZ coordinates of the endpoint, which is the endpoint information of polygon p, z of pixel(x,y) is calculated by linear interpolation.

Next, in step S22, a depth value of the first depth buffer 4 corresponding to pixel(x,y), z1(x,y), is obtained. In step S23, the depth value of polygon p, which is a target at the moment, at a pixel(x,y) included in polygon p, pz(x,y), and the obtained depth value of the first depth buffer 4, z1(x,y), are compared. If pz(x,y) is equal to or lower than z1(x,y), polygon p is the closest to the point of view at the moment for pixel(x,y). Therefore, processes of steps S24 through S29 are performed.

Specifically, in steps S24 and S25, color information of the second color buffer 7 corresponding to pixel(x,y), c2(x,y), and a depth value of the second depth buffer 8, z2(x,y), are respectively substituted by color information of the first color buffer 3, c1(x,y), and the depth value of the first depth buffer 4, z1(x,y). By performing such a process, for pixel(x,y), the color information, and the depth value of the polygon closest to the point of view at the point immediately before rendering polygon p, becomes the color information and the depth value of the polygon second closest to the point of view at the moment.

In step S26, the color information of polygon p at pixel(x,y), pc(x,y), the edge identification information regarding whether pixel(x,y) is located in the edge portion of polygon p, pe(x,y), and the percentage of the area in pixel(x,y) which is occupied by polygon p, pa(x,y), are obtained.

In steps S27 through S29, the depth value of the first depth buffer 4 corresponding to pixel(x,y), z1(x,y), the color information of the first color buffer 3, c1(x,y), the edge identification information of the edge identification buffer 5, e(x,y), and a mixing coefficient of the mixing coefficient buffer 6, a(x,y), are respectively substituted by the depth value pz(x,y), color information pc(x,y), the edge identification information pe(x,y), and the percentage of the area pa(x,y) of polygon p at pixel(x,y).

By performing the serial processes through steps S24 through S29, data which has been the data of the polygon closest to the point of view becomes the data of the second closest to the point of view. The data area of the polygon which is now closest to the point of view is replaced by the data of polygon p.

The value of the edge identification information of polygon p at pixel(x,y), pe(x,y), is “0” when the edge of polygon p is not located at pixel(x,y), and is “1” when the edge of polygon p is located at pixel(x,y).

In step S23, in the case where the depth value of polygon p at pixel(x,y) included in polygon p, pz(x,y), is greater than the depth value of the first depth buffer 4 corresponding to pixel(x,y), z1(x,y), the depth value of the second depth buffer 8 corresponding to pixel(x,y), z2(x,y), is obtained in step S31. In step S32, pz(x,y) and z2(x,y) are compared. If pz(x,y) is equal to or lower than z2(x,y), polygon p is the second closest polygon from the point of view for pixel(x,y). Thus, process of steps S33 and S34 is performed.

Specifically, in steps S33 and S34, color information of polygon p at pixel(x,y), pc(x,y), is provided. The depth value of the second depth buffer 8 corresponding to pixel(x,y), z2(x,y), and the color information of the second color buffer 7, c2(x,y), are respectively substituted by the depth value pz(x,y) and the color information pc(x,y) of polygon p at pixel(x,y). By this process, the data area of the polygon which is the second closest to the point of view is replaced by the data of polygon p.

In step S32, in the case where pz(x,y) is greater than z2(x,y), polygon p is further than the second closest polygon from the point of view at pixel(x,y). Thus, substitution to the respective buffers is not performed, and the hidden surface removal process for polygon p at pixel(x,y) is completed.

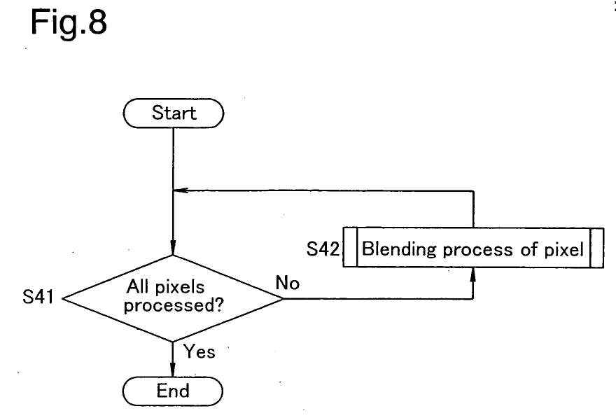

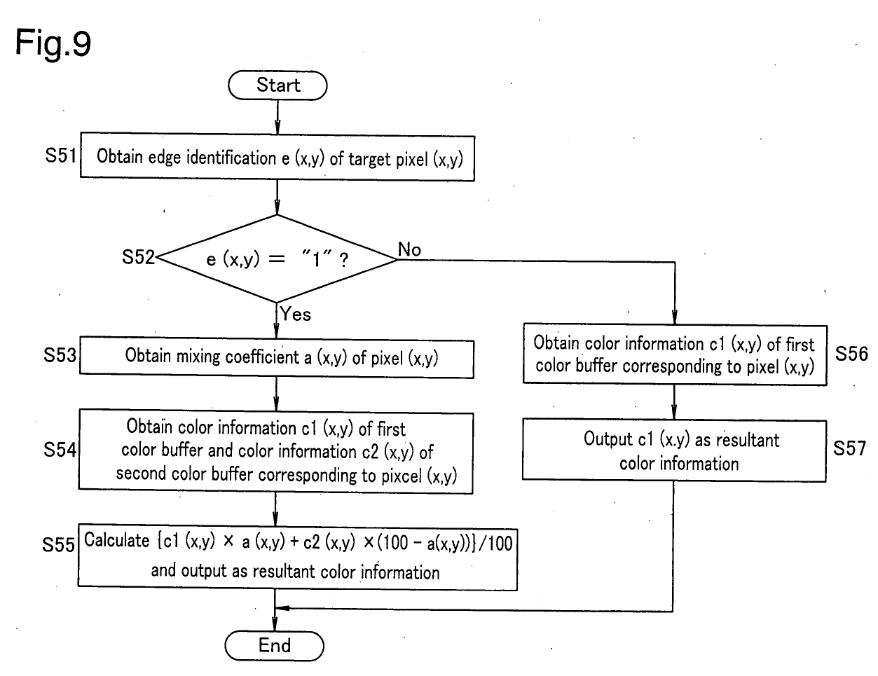

Next, an operation of the blending section 2 will be further described in detail with reference to FIGS. 8 and 9.

FIG. 8 is a flow diagram for illustrating an outline of a blending process performed by the blending section 2 of FIG. 1.

As shown in FIG. 8, in step S41, it is determined whether the blending process is completed for all the pixels. If the blending process is not completed for all the pixels, the method proceeds to the blending process for each of the pixels in step S42. If the blending process is completed for all the pixels, the blending process is completed.

Now, details of a blending process operation for one pixel (step S42 of FIG. 8) will be described with reference to FIG. 9.

FIG. 9 is a flow diagram for illustrating a process performed in the blending process operation (step S42) in detail.

As shown in FIG. 9, in step S51, the edge identification information of pixel(x,y) which is the pixel of interest at the moment, e(x,y), is obtained. In step S52, it is determined whether the value of the edge identification information, e(x,y), is “1” or not. When the value is “1”, the edge of the polygon which is closest to the point of view is located at pixel(x,y). Thus, the processes of steps S53 through S55 are sequentially performed.

Specifically, the mixing coefficient of pixel(x,y), a(x,y), is obtained in step S53. Then, the color information of the first color buffer 3 for pixel(x,y), c1(x,y), and the color information of the second color buffer 7, c2(x,y), are obtained in step S54.

In S55, color information c1(x,y) and the color information c2(x,y) are blended with mixing coefficient a(x,y). The blended value is output as the color information of the resultant image (see, for example, FIG. 4). Blending is performed in accordance with the following formula:
{c1(x,y)×a(x,y)+c2(x,y)×(100-a(x,y))}/100.

Mixing coefficient a(x,y) is the percentage of the area in the pixel(x,y), which is occupied by the first polygon closest to the point of view. The color information of the first polygon which is closest to the point of view, c1(x,y), and the color information of the second polygon which is second closest to the point of view (behind the first polygon), c2(x,y), are blended with the mixing coefficient a(x,y). Thus, it becomes possible to obtain a more natural image with reduced ailiasing.

If the edge identification information e(x,y) is not “1” in step S52, the process of steps S56 and S57 is performed.

Specifically, in step S56, the color information of the first color buffer 3 at pixel(x,y), c1(x,y), is obtained. In step S57, c1(x,y) is output as the color information of the resultant image (see, for example, FIG. 4).

The case where edge identification information e(x,y) is not “1” is the case where the edge of the first polygon, which is closest to the point of view, is not located in pixel(x,y). Thus, outputting the color information of the first polygon which is the closest to the point of view, c1(x,y), as the color information of the resultant image does not result in a blurred image with respect to pixels other than those in the edge portion.

As described above, according to the present embodiment, the three dimensional image rendering apparatus 10 includes: the first color buffer 3 for storing color information of the first polygon which is closest to the point of view for the respective pixels forming the display screen; the first depth buffer 4 for storing the depth buffer; the edge identification buffer 5 for storing the edge identification information; the mixing coefficient buffer 6 for storing the percentage of the area; the second color buffer 7 for storing the color information of the second polygon which is second closest to the point of view (behind the first polygon); the second depth buffer 8 for storing the depth value; the hidden surface removal section 1 for obtaining the first polygon and the second polygon for respective pixels to update the data in the buffers 3 through 8; and blending section 2 for mixing the data of the first color buffer 3 and the data of the second color buffer 7, based on data in the edge identification buffer 5 and the mixing coefficient buffer 6, to obtain the color information of the respective pixels.

With such a structure, graphic data including endpoint information and the color information are transformed into a view coordinate system of a polygon forming a three dimensional object. Based on the depth value of the polygon, the hidden surface removal process is performed. The first polygon which is closest to the point of view and the second polygon which is second closest to the point of view (behind the first polygon) are obtained for the respective pixels. The color information, the edge identification information and the percentage of the area in the pixel of the first polygon, and color information of the second polygon are respectively stored in the buffers. By blending the color information of the first polygon and the color information of the second polygon based on the edge identification information and the percentage of the area relative to the pixel of the first polygon, it is possible to render an image with reduced ailiasing. Thus, an anti-ailiasing process can be performed without requiring a large amount of memory region or long processing time, unlike the conventional method such as a super sampling method, or without resulting in a generally blurred image unlike another conventional method such as a filtering method.

In the present embodiment, it is also possible to provide the first color buffer 3, the first depth buffer 4, the edge identification information buffer 5, the mixing coefficient buffer 6, the second color buffer 7 and the second depth buffer 8 with a capacity corresponding to one line in the display screen, and to perform the process for every line by the hidden surface removal section 1 and the blending section 2. In the case where the buffers 3 through 8 are provided with a capacity corresponding to one line, a required memory capacity is small. With such a structure, the three dimensional image rendering apparatus 10 of the present invention can be readily mounted in a portable electronic device such as a portable game device.

In the field of the three dimensional image rendering apparatus, and the three dimensional image rendering method for rendering a three dimensional image on a two dimensional display screen of a portable electronic device, such as a portable game device, it is possible to reduce ailiasing while requiring a smaller memory capacity compared to that for the conventional super sampling method and with a high speed, and produce a three dimensional image having a high image definition.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

1. A three dimensional image rendering apparatus for rendering polygons forming a three dimensional object on a two dimensional display screen, comprising:
a hidden surface removal section for performing a hidden surface removal process by, when a part or all of the pixels forming the two dimensional display screen belong to a first polygon which is closest to a point of view, updating memory contents in an information memory section to information of the first polygon; and
a blending section for obtaining, based on edge identification information for indicating whether the respective pixels are located on an edge of the first polygon, and a percentage of an area in the respective pixels occupied by the first polygon as part of information of the first polygon, the color information of the respective pixels from color information as another part of the first polygon, and outputting the color information of the respective pixels as pixel data.

2. A three dimensional image rendering apparatus according to claim 1, wherein:
the hidden surface removal section further updates, when the respective pixels belong to the first polygon and also to a second polygon, which is the second closest to the point of view memory contents of the information memory means regarding the second polygon to information of the second polygon; and
the blending section mixes, based on the edge identification information and the percentage of the area as the part of the information of the first polygon, the color information as another part of the information of the first polygon, and color information as a part of the information of the second polygon to obtain color information of the respective pixels, and outputs the color information of the respective pixels as pixel data.

3. A three dimensional image rendering apparatus according to claim 2, wherein:
the information memory section includes a first color memory section for storing the color information of the first polygon, a first depth memory section for storing a depth value of the first polygon, an edge identification memory section for storing the edge identification information for indicating whether the respective pixels are located on the edge of the first polygon, a mixing coefficient memory section for storing the percentage of the area in the respective pixels which is occupied by the first polygon, a second color memory section for storing the color information of the second polygon which is located second closest to the point of view, and a second depth memory section for storing a depth value of the second polygon; and
the hidden surface removal section obtains the color information, the depth value, the identification information, and the percentage of the area of the first polygon as the information of the first polygon, and the color information and the depth value of the second polygon as the information of the second polygon.

4. A three dimensional image rendering apparatus according to claim 2, wherein:
the hidden surface removal section includes a polygon determination section for receiving, as an input graphic data including endpoint information and color information of the polygon, which are transformed into a view coordinate system, obtaining depth values for the respective pixels from the endpoint information of the polygon, and, based on the depth values, determining whether the part or all of the pixels respectively belong to the first polygon which is closest to the point of view and/or to the second polygon which is second closest to the point of view.

5. A three dimensional image rendering apparatus according to claim 3, wherein:
the hidden surface removal section updates the memory contents of the first color memory section, the first depth memory section, the edge identification information memory section, the mixing coefficient memory section, the second color memory section and the second depth memory section using the information of the first polygon when the part or all of the pixels respectively belong to the first polygon.

6. A three dimensional image rendering apparatus according to claim 5, wherein:
the hidden surface removal section further updates the memory contents of the second color memory section and the second depth memory section, using the information of the second polygon when the respective pixels respectively belong to the first polygon and the second polygon.

7. A three dimensional image rendering apparatus according to claim 6, wherein:
the blending section mixes the memory contents of the first color memory section, and the memory contents of the second color memory section, based on the memory contents of the edge identification information memory section, and the mixing coefficient memory section, to obtain color information of the respective pixels, and outputs the color information of the respective pixels as image data.

8. A three dimensional image rendering apparatus according to claim 3, wherein:
the first color memory section, the fist depth memory section, the edge identification information memory section, the mixing coefficient memory section, the second color memory section and the second depth memory section respectively have memory capacities corresponding to one line in the display screen, and the hidden surface removal section and the blending section performs processing for every line of one screen.

9. A three dimensional image rendering method for rendering polygons forming a three dimensional object on a two dimensional display screen, comprising:
a first step of obtaining information of at least one of a first polygon which is closest to a point of view, and a second polygon which is second closest to the point of view for respective pixels forming the display screen; and
a second step of mixing color information of the first polygon and color information of the second polygon based on edge identification information indicating whether the respective pixels are located on an edge of the first polygon, and the percentage of the area in the respective pixels, which is occupied by the first polygon, to obtain color information of the respective pixels, and outputting the color information of the respective pixels as image data.

10. A three dimensional image rendering method according to claim 9, wherein:
the first step receives graphic as an input, data including endpoint information and color information of the polygon, which are transformed into a view coordinate system, obtains depth values for the respective pixels from the endpoint information of the polygon, and, based on the depth values, obtains the color information of the first polygon, a depth value of the first polygon, the edge identification information indicating whether the respective pixels are located on the edge of the first polygon, the percentage of the area in the respective pixels occupied by the first polygon, the color information of the second polygon, and a depth value of the second polygon.
